(19) United States
(12) Patent Application Publication
(10) Pub. No.: US 2025/0257812 A1
(43) Pub. Date: Aug. 14, 2025

(54) Valve

(71) Applicant: HYDAC Fluidtechnik GmbH, Sulzbach / Saar (DE)

(72) Inventors: Peter Bruck, Althornbach (DE); Jörg Fassian, Merchweiler (DE); Desiree Risch, Eppelborn (DE)

(73) Assignee: HYDAC Fluidtechnik GmbH, Sulzbach / Saar (DE)

(21) Appl. No.: 18/853,361

(22) PCT Filed: Sep. 8, 2023
(86) PCT No.: PCT/EP2023/074714

§ 371 Date: Oct. 1, 2024

(30) Foreign Application Priority Data
Oct. 28, 2022 (DE) 10 2022 004 033.6

(51) Int. Cl. F16K 15/18; F16K 15/02; F16K 31/06; F16K 31/122

(52) U.S. Cl. CPC F16K 15/184; F16K 15/026; F16K 31/0675; F16K 31/1221

(57) ABSTRACT

The disclosure relates to a valve comprising a valve housing which has two fluid connection points for guiding a fluid and comprising an actuation device for actuating a main piston of a seat valve, said main piston being received in the valve housing. The valve housing together with the seat valve receives a nonreturn valve. At least one bypass line runs in the valve housing, said bypass line allowing a flow of fluid present at the fluid connection point in the direction of a valve chamber in the open state of the seat valve while bypassing the nonreturn valve, said flow being controllable by the main piston of the seat valve.

### CROSS-REFERENCE TO RELATED APPLICATIONS

This application claims priority to German Patent Application No. DE 10 2022 004 033.6, filed on Oct. 28, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a valve comprising a valve housing which has two fluid connection points for guiding fluid and comprising an actuation device for actuating a main piston of a poppet valve, said main piston being received in the valve housing, wherein a non-return valve is received in the valve housing together with the poppet valve.

DE 10 2012 015 354 A1 discloses a valve, in particular a pilot-operated proportional directional valve, having a valve housing comprising a fluid inlet and a fluid outlet, wherein the fluid flow between the fluid inlet and the fluid outlet can be controlled by a main piston, wherein a pilot control valve chamber is provided on a rear side of the main piston with a pilot control valve closing element that can be moved by an actuation device, the fluid flow being able to be controlled between the pilot control valve chamber and the fluid outlet by means of said pilot control valve closing element, wherein an inflow orifice is arranged between the fluid inlet and the pilot control valve chamber, the opening cross-section of said inflow orifice being able to be reduced by a control element.

Furthermore, a maximum volume flow controller is provided inside the valve housing, said flow controller comprising a control piston in the form of a spring-loaded non-return valve, said control piston being loaded on a front side by the pressure of the fluid discharged from the pilot control chamber and on a rear side by a compression spring. As such, a flow controller is integrated inside the valve and the inflow orifice cross-section, which can be reduced in size by means of the control element, causes the pressure in the pilot control valve chamber to fall such that it is possible to actively control the opening stroke of the main piston in addition to controlling the pilot control valve seat. The lower the differential pressure between the fluid inlet and the fluid outlet, the larger the opening stroke of the valve can be set to be to permit the flow control function.

### SUMMARY

A need exists to provide a valve which combines two different valve types with one another in a shared housing in a space-saving manner. This may, e.g., increase the application possibilities for such valve constructions.

The need is addressed by the subject matter of the independent claim(s). Embodiments of the invention are described in the dependent claims, the following description, and the drawings.

### BRIEF DESCRIPTION OF THE DRAWINGS

FIG. 1 shows the form of a longitudinal section through a de-energised example opened valve in an unactuated position;

FIG. 2 shows the same example valve as in FIG. 1 in an activated and thus closed position;

FIG. 3 shows an example hydraulic circuit for the de-energised open example valve according to FIG. 1;

FIG. 4 takes the form of a longitudinal section through a further de-energised example closed valve in an unactuated position;

FIG. 5 shows the same example valve as in FIG. 4 in an activated and thus open position; and

FIG. 6 shows an example hydraulic circuit for the de-energised closed valve according to FIG. 4.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, at least one bypass line runs in the valve housing, said bypass line routing a fluid flow present at one fluid connection point in the direction of a valve chamber when the poppet valve is in the open state, while bypassing the non-return valve. Said flow being able to be controlled by the main piston of the poppet valve, the non-return valve integrated in the valve housing is, if required, in a position to be able to discharge fluid on the consumer side via the valve into the abutting fluid circuit at a very low opening pressure and with low throughflow loss, in turn with a relatively large opening cross-section.

As such, it is possible to increase the scope of application for such valve constructions. For example, the valve can be very readily combined with hydraulic damping cylinders as the consumer, in particular in the form of so-called stabilisers as part of a vehicle chassis. By using the valve, the respective stabiliser is designed to be operated more rigidly when cornering than when driven off-road, when a softer spring compression of the chassis is generally desirable.

In some embodiments, the poppet valve is a 2/2 directional poppet valve, in particular a pilot-operated 2/2 directional poppet valve. As such, in the opposite direction to the non-return valve, the volume flow can be released as a function of the switching position of the tightly seated 2/2 directional valve by means of an electrical signal to the actuation device. In some embodiments 10 as a modular system, the 2/2 directional poppet valve can be normally open (NO) or normally closed (NC) in the basic position depending on the version selected. The internal return of the fluid from one connection point in the valve housing to the rear side of the 2/2 directional poppet valve makes it possible to configure the valve accordingly with only two ports. For example, in this process, the non-return valve is arranged in a fluid connection between one and the other fluid connection point in the valve housing.

For example, the non-return valve comprises a spring-loaded closing body, which blocks the fluid connection in the direction of the other fluid connection point as soon as the fluid pressure at one fluid connection point is higher than at the other fluid connection point. If, on the other hand, the fluid pressure at the other fluid connection point is higher than at the first fluid connection point, the non-return valve opens.

The aforementioned modular system for the valve permits solutions in which, in an actuated position of the 2/2 directional poppet valve, a fluid passage from the bypass line into the valve chamber is blocked or released and, in an unactuated position, it is released or blocked respectively.

Particularly favourable flow forces arise when introducing fluid into the valve if, adjacent to the further fluid connection point and opposite one another, viewed in the active direction, the closing body of the non-return valve and the piston-like main piston of the 2/2 directional poppet valve are guided in a longitudinally displaceable manner in the valve housing, wherein the valve chamber is permanently connected to the further fluid connection point in a fluid-conveying manner. In particular, the closing and main piston are arranged concentrically with respect to the longitudinal or displacement axis of the valve.

For example, in this case it may be provided that an orifice is permanently connected between the valve chamber and the further fluid connection point. By virtue of this optional integration of an orifice, it is possible to monitor the volume flow via the 2/2 directional poppet valve.

In some embodiments, it is further provided that the pilot control of the poppet valve comprises a pilot control piston, which engages through the main piston of the poppet valve and which is operatively connected to the main piston, for example by means of an energy accumulator, such as a compression spring. For the purpose of indirect control of the main piston, the actuation device acts exclusively on the pilot control piston in this process.

For example, the pilot control piston controls an axial orifice in the main piston, which orifice, in the released state, establishes a permanent fluid connection between the valve chamber and a pilot control chamber, which is at least partially delimited by the valve piston. In addition, the main piston comprises a radial orifice, which can be supplied with fluid via a fluid passage between the outer circumference of the main piston and the adjacent inner circumference of the valve housing and which emerges in the pilot control chamber. When the pilot control piston is opened, i.e., the pilot control piston has lifted off the pilot control seat of the main piston, pilot control oil flows via the series-connected radial orifice and the pilot control seat or axial orifice respectively, wherein the resulting pressure difference at the radial orifice ensures a lower pressure in the pilot control chamber, which ultimately opens the poppet valve by means of the main piston. The free diameter of the radial orifice is in this case selected to be slightly smaller than the free diameter of the axial orifice. Otherwise, such valve pilot controls may be state of the art, as is shown for example in DE 10 2012 015 354 A1.

For example, the actuation device used comprises a solenoid and when said solenoid is energised, a solenoid armature actuates the pilot control valve such that the main piston which is thus controlled indirectly moves into a position which blocks the fluid passage between the respective bypass line and the valve chamber or into a position releasing said fluid passage respectively.

The valve is discussed in greater detail below with reference to the drawings and further embodiments. Specific references to components, process steps, and other elements are not intended to be limiting. The drawings are not to scale.

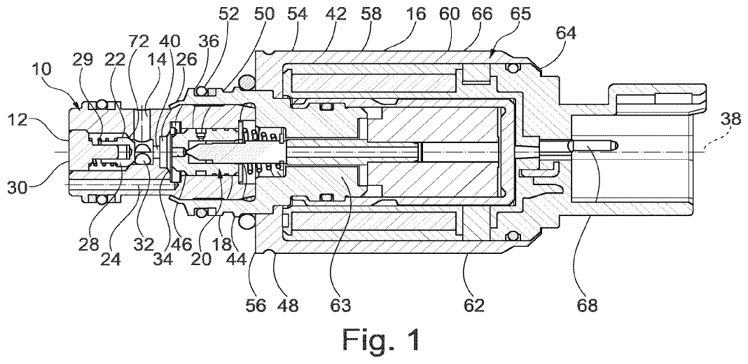

The valve shown in FIG. 1 comprises a valve housing referred to in its entirety as 10. The valve housing 10 can be constructed in multiple parts as shown in FIG. 1 and may be received by means of corresponding sealing systems in a valve block, which is not shown in further detail, in the customary manner. The valve housing 10 comprises two fluid connection points 12, 14 for guiding fluid, for example in the form of a hydraulic medium. Furthermore, the valve comprises an actuation device referred to in its entirety as 16 for actuating a main piston 18 received in the valve housing 10, said main piston forming part of a poppet valve referred to in its entirety as 20. Together with the poppet valve 20, a non-return valve 22 is received in the aforementioned valve housing 10. It is characteristic that, starting from the free end face of the valve housing 10, a bypass line 24 at least partially passes through said valve housing, said bypass line routing a fluid flow present at one fluid connection point 12 in the direction of a valve chamber 26 when the poppet valve 20 is open, while bypassing the non-return valve 22, and as such this fluid flow is controlled by the main piston 18 of the poppet valve 20. The main or valve piston 18 and the pilot control piston 44 form a 2/2 directional poppet valve; in particular, this is a pilot-operated 2/2 directional poppet valve, which is explained in further detail below.

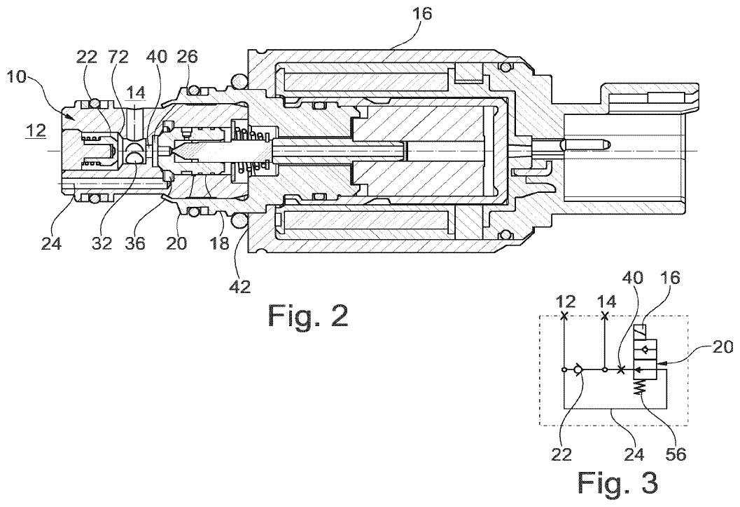

The non-return valve 22 is arranged in a fluid connection between one 12 and the other fluid connection point 14. The non-return valve 22 comprises a spring-loaded closing body 28, which blocks the fluid connection in the direction of the other fluid connection point 14 as soon as the fluid pressure at one fluid connection point 12 is higher than at the other fluid connection point 14. In FIG. 1, the closing body 28 is in its position blocking the aforementioned fluid connection; which is supported by a closing spring 29, which is designed as a compression spring and acts on the closing body 28. The non-return valve 22 comprises a so-called tripod 30 facing the fluid connection point 12 on the inlet side, which makes it possible to implement the fluid flow between the legs of the tripod 30 to establish the aforementioned fluid connection. When the non-return valve 22 is opened, as shown in FIG. 2, fluid which is present at the further fluid connection point 14 therefore flows via the aforementioned fluid connection unimpeded in the direction of the fluid connection point 12. When the non-return valve 22 is opened, oil therefore always flows from the connection point 14 to the connection point 12, as the non-return valve 22 pushes itself up. When the non-return valve 22 is closed, the corresponding fluid path is blocked. By creating a permanent fluid connection to a fluid chamber 32 in the valve housing 10, the channel-like further fluid connection point 14 engages radially in the valve housing 10. The channel-like fluid connection point 14 can, in this process, be distributed multiple times along the outer circumference of the valve housing 10, creating the fluid connection to the central fluid chamber 32.

The main piston 18 is configured as a valve piston of the poppet valve 20 and is shown in FIG. 1 in its open position. In this case, the free end face of the main piston 18 lifts off a conically extending valve seat 34 in the valve housing 10. When the poppet valve 20 is opened, as shown in FIG. 1, a fluid connection is established via the valve seat 34 between a pre-valve chamber 36 and the actual valve chamber 26. In this process, the pre-valve chamber 36 is selected such that its diameter is larger than the valve chamber 26, and the valve seat 34 with its walls ensures the transition between the two chambers 26 and 36. Furthermore, the pre-valve chamber 36 is permanently connected to the bypass line 24, which extends parallel to a longitudinal axis 38 of the valve, wherein, although this is not shown in more detail, a plurality of corresponding bypass lines may if necessary also be received in a parallel arrangement to the longitudinal axis 38 and radially spaced apart from one another in the valve housing 10. Furthermore, an orifice 40 with a predefinable cross-section is provided between the valve chamber 26 and the fluid chamber 32.

The difference in diameter between the piston diameter of the main piston 18 and the valve seat 34 forms a kind of circular ring and the surface area of this circular ring is selected such that it is approximately half the size of the rear side of the piston arranged opposite thereto, which forms the largest diameter. If the pressure on the rear side of the main piston 18 is almost half as high as the pressure on the aforementioned circular ring, the piston is then able to move to the right as viewed on FIG. 1. The corresponding diameter configuration for a main piston 18 is standard in a pilot-operated poppet valve 20, with the result that no further detail is provided in this respect at this juncture. The aforementioned pilot control for the main piston 18, i.e., for the poppet valve 20, is referred to in its entirety as 42. The aforementioned pilot control 42 has a pilot control piston 44, which engages through the main piston 18 while partly maintaining a radial distance from said main piston. As shown in FIG. 1, in this process a piston tip of the pilot control piston 44 engages through an axial orifice 46 in the main piston 18 and, when the axial orifice 46 is released via the pilot control piston 44, this creates a fluid-conveying connection between a pilot control chamber 48 and the chamber 26.

Furthermore, the piston-shaped main piston 18 has a radial orifice 50 on an outer circumference, which, via a channel-like fluid passage 52, is connected in a permanently fluid-conveying manner to the pre-valve chamber 36 and, as such, is in permanent fluid connection with the bypass line 24, which is connected to the fluid connection point 12. In particular, the channel-like fluid passage 52 is created via a recessed groove along the outer circumference of the main piston 18.

The rear side of the main piston 18 is not supported on a plate guide 54, through which the pilot control piston 44 engages and which instead serves as a contact for a conical compression spring 56, which is in contact via its other free end with a further plate guide 58, which is securely connected to the pilot control piston 44. The piston stroke of the main or valve piston 18 is limited by the fact that, when the main piston 18 reaches the pilot control piston 44, the pilot control oil flow has dried up and the main piston 18 is then no longer able to open any further.

The pilot control piston 44 can be controlled by an actuating rod 60, particularly guided in a longitudinally displaceable manner in the housing of the actuation device 16, i.e., inside the solenoid assembly, wherein one end of the actuating rod 60 is in contact with the pilot control piston 44 and the other end or end region of the actuating rod engages in a customary manner in a solenoid armature 62, which can be guided in a longitudinally displaceable manner in a pole tube 64, and when a coil winding 66 of the actuation device 16 is energised, moves from its de-energised starting position according to FIG. 1 into its energised actuation position according to FIG. 2, wherein, in this manner, the main piston 18 can be controlled indirectly via the pilot control piston 44, in particular moved into its closing position as shown on FIG. 2, in which the fluid connection between the pre-valve chamber 36 and the valve chamber 26 is interrupted in that, specifically, the conical contact part of the main piston 18 comes into contact with the valve seat 34 in the valve housing 10. The pilot control piston 44 closes the valve seat 46. As a result, the pilot control oil flow dries up and no further pilot control oil flows at the radial orifice 50. Thus, the pressure difference via this orifice becomes zero and the same pressure prevails on the rear side of the main piston 18 as on the circular ring 36. Due to the circumstance that the rear side of the piston of the main piston 18 is twice the surface area of the circular ring 36, this leads to a force that closes the main piston 18.

The aforementioned pilot control with an axial orifice 46 and a radial orifice 50 may also be standard (DE 10 2012 015 354 A1), with the result that no further detail is provided in this respect at this juncture. The actuation device 16 therefore acts as shown on the pilot control piston 44 and closes or opens the pilot control seat in the form of the axial orifice 46 in the energised or de-energised state. When the pilot control piston 44 is opened, pilot control oil also flows in the direction of the valve chamber 26 with a further orifice 40 via the series-connected radial orifice 50 and the pilot control seat in the form of the axial orifice 46, wherein the pressure difference at the radial orifice 50 ensures a lower pressure in the pilot control chamber 48, which ultimately leads to the main piston 18 opening as shown in FIG. 1. Thanks to the pilot control stage, i.e., due to the pilot control 42, the poppet valve 20 can be actuated with low magnetic forces and thus in an energy-saving manner by means of the actuation device 16. It is clear that, in order to energise the coil winding 66, the actuation device 16 must be able to be connected to a power supply source by means of a plug 68 in the customary manner. To ensure that no obstacles to operation of the solenoid armature 62 arise, both the actuating rod 60 and the solenoid armature 62 are provided with a through hole, such that the pressure prevailing in the pilot control chamber 48 also acts on the rear side of the solenoid armature 62 and thus allows pressure-compensated valve operation.

As is also evident from the circuit diagram shown in FIG. 3, a hydraulic consumer which is not shown in further detail, for example in the form of a hydraulic operating cylinder, such as a damping or stabiliser cylinder, is connected on the outlet side of the valve between the two fluid connection points 12, 14. The non-return valve 22 is also connected on the valve side between the fluid connection points 12, 14, said valve closing in the direction of the connection point 14 and opening in the reverse direction. Furthermore, at least one individual bypass line 24 is connected to the fluid connection point 12 and bypassing the non-return valve 22, said bypass line in turn being connected on the outlet side to the electromagnetically actuatable poppet valve 22 on the inlet side, which, as shown in FIG. 3, is held in the opened position as shown in FIG. 1 by means of the pilot control 42, wherein, accordingly, the actuation device 16 is not energised and the open position (NO) is reached by using the compression spring 56.

However, as, according to the drawing in FIG. 2, the main piston 18 of the poppet valve 20 is kept closed by the actuation device 16 with a magnetic force that is in the magnitude of approximately 8 to 10 bar fluid pressure, the internal non-return valve function only comes into play when, in the context of pressure protection, the fluid pressure present in the valve chamber 26 is higher than the magnetic force of the actuation device 16 keeping the main piston 18 closed. Under normal circumstances, it is simply the case that when the fluid pressure at the further fluid connection point 14 is higher than at the first fluid connection point 12, the non-return valve 22 opens in the direction of the fluid connection point 12 and thus releases the fluid connection from 14 to 12, specifically via the fluid chamber 32 in the valve housing 10. The non-return valve 22 that is used accordingly has only a very small opening pressure of 0.2 to 0.5 bar, for example; however, as shown in FIG. 2 in particular, this releases a very large throughflow cross-section between the closing body 28 of the non-return valve 22 and the assigned adjacent valve seat 72 in the valve housing 10, such that, when there is an extremely low pressure difference, a discharge takes place via the fluid connection point 12 from one actuator side of the hydraulic consumer to the other actuator side, to which the valve is connected as shown in the figures.

Even when controlling the poppet valve 20, the valve design dictates that for example up to 95% fluid flows from the connection point 14 to the connection point 12, whereas via the poppet valve 20 only approximately 5% fluid is intended to be returned to the fluid connection point 12 from the fluid connection point 14 via the poppet valve 20 and the bypass line 24, bypassing the non-return valve 22, which is unobjectionable. In order to keep the non-return function of the non-return valve 22 “moderate”, i.e., to ensure a low opening pressure with low pressure losses AP, the associated closing spring 29, which controls the closing body 28, is only provided with a low spring force and is thus responsible for the near-time opening operation with the closing body 28 at low fluid pressures in a correspondingly “softly” actuated manner.

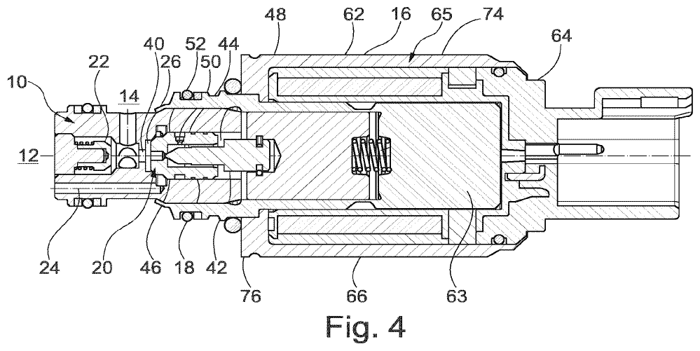

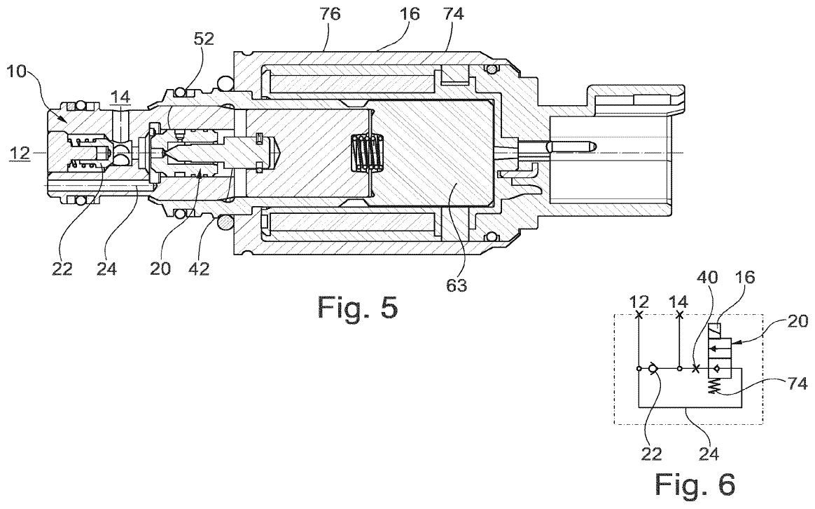

While FIG. 1 shows a valve solution in which the valve is opened in the de-energised state (NO), FIG. 2 shows the closed valve solution in the energised state. When the pilot control piston 44 is opened, the valve tightens when the flow passes from the valve chamber 26 to the valve chamber 36 and only a limited volume flow is possible via the two orifices 46, 50. In the embodiment shown in FIGS. 4 and 5, in the de-energised state, the valve assumes its closed position (NC) or, as shown in FIG. 5, the valve is opened in the energised state. For this purpose, the compression spring 56 shown in FIGS. 1 to 3 is omitted and instead such a compression spring 74 is arranged between the movable solenoid armature 62 and a pole core 63 of the pole tube 64. The aforementioned components are surrounded by a solenoid housing 65. Furthermore, the pilot control piston 44 is securely connected via a snap ring connection 76 to one of the free end faces of the solenoid armature 62. If the actuation device 16 is thus de-energised, the compression spring 74 exerts a force on the solenoid armature 62 and, in this manner, the pilot control 42 is controlled such that the main piston 18 of the poppet valve 20 passes into its closing position as shown on FIG. 4.

If, however, as shown on FIG. 5, the actuation device 16 is energised, by pressing together the compression spring 74, the solenoid armature 62 passes into its right-hand actuation position, as shown in the viewing direction, in which the pilot control 42 controls the main piston 18 such that a releasing fluid connection is established between the fluid connection points 12, 14 via the respective bypass line 24, the pre-valve chamber 36, the thus released valve seat 34, the valve chamber 26, the orifice 40, the fluid chamber 32 and the radial channel passage to the fluid connection point 14 from the direction of the connection point 12. Otherwise, the structure of the valve according to FIGS. 4 and 5 substantially corresponds to the structure of the valve shown in FIGS. 1 and 2, and it is clear that a kind of modular system is thus created in which various types of such valves can be produced in a standardised construction with few basic components. As such, the same components, along with the same reference numerals, are reproduced for all structural components of the valves shown in FIGS. 1 to 6 and the explanations thus provided for the first embodiment also apply accordingly to the second embodiment.

FIG. 6 shows a corresponding circuit diagram position as shown in FIG. 3; this time for the valve solution according to FIGS. 4 and 5. Accordingly, the poppet valve 20 is closed in the de-energised state (NC) (FIG. 4) and opened in the energised state (FIG. 5). Accordingly, all valve solutions according to FIGS. 1 to 6, fulfil the central object of guiding the fluid volume flow in a flow direction, for example from the fluid connection point 14 to the fluid connection point 12 via the non-return valve 22 with a very small opening pressure and low throughflow losses, whereas, as a function of the switching position of the tightly seated 2/2 directional poppet valve 20, the volume flow from the port 12 to the port 14 is blocked or released by means of an electrical signal to the actuation device 16. The volume flow can be manifestly influenced in this process with the aid of the orifice 40. The 2/2 directional poppet valve 20 can be normally open (NO), as shown in FIG. 1 or normally closed (NC), as shown in FIG. 4 depending on the version. By integrating two valves 20 and 22 in a shared valve housing 10, there is no need for additional valves and associated external pipework, which helps save costs and increases functional reliability.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-12. (canceled)

13. A valve comprising a valve housing which has two fluid connection points for guiding fluid and comprising an actuation device for actuating a main piston of a poppet valve, said main piston being received in the valve housing, wherein the valve housing together with the poppet valve receives a non-return valve, wherein at least one bypass line runs in the valve housing, said bypass line routing a fluid flow present at one fluid connection point in the direction of a valve chamber when the poppet valve is in the open state, while bypassing the non-return valve, said flow being able to be controlled by the main piston of the poppet valve.

14. The valve of claim 13, wherein the poppet valve is a 2/2 directional poppet valve.

15. The valve of claim 13, wherein the non-return valve is arranged in a fluid connection between one and the other fluid connection point.

16. The valve of claim 13, wherein the non-return valve comprises a spring-loaded closing body, which blocks the fluid connection in the direction of the other fluid connection point as soon as the fluid pressure at one fluid connection point is higher than at the other fluid connection point.

17. The valve of claim 13, wherein a fluid passage from the bypass line into the valve chamber is a) normally closed in an actuated position and normally open in an unactuated position of the poppet valve or b) normally open in the actuated position and normally closed in the unactuated position of the poppet valve.

18. The valve of claim 13, wherein, adjacent to the further fluid connection point and opposite one another, the closing body of the non-return valve and the main piston of the poppet valve are guided in a longitudinally displaceable manner in the valve housing and in that the valve chamber is permanently connected to the further fluid connection point in a fluid-conveying manner.

19. The valve of claim 13, wherein an orifice is connected between the valve chamber and the further fluid connection point, said orifice being able to generate a differential pressure which is dependent on the volume flow in a throughflow direction from the fluid connection point to the further fluid connection point.

20. The valve of claim 13, wherein the pilot control of the poppet valve comprises a pilot control piston, which engages through the main piston of the poppet valve, and which is operatively connected to the pilot control piston

21. The valve of claim 13, wherein, for the purpose of indirect control of the main piston, the actuation device acts exclusively on the pilot control piston.

22. The valve of claim 13, wherein the pilot control piston controls an axial orifice in the main piston, which, in the released state, creates a permanent fluid connection between the pilot control chamber and the valve chamber.

23. The valve of claim 13, wherein the main piston also has a radial orifice, which can be supplied with fluid via a fluid passage between the outer circumference of the main piston and the adjacent inner circumference of the valve housing and which emerges in the pilot control chamber.

24. The valve of claim 13, wherein the actuation device comprises a coil winding and when said coil winding is energised, a solenoid armature actuates the pilot control valve such that the main piston moves into a position that blocks the fluid passage between the respective bypass line and the valve chamber or into a position releasing said fluid passage respectively.

25. The valve of claim 13, wherein the poppet valve is a pilot-operated 2/2 directional poppet valve.

26. The valve of claim 14, wherein the non-return valve is arranged in a fluid connection between one and the other fluid connection point.

27. The valve of claim 14, wherein the non-return valve comprises a spring-loaded closing body, which blocks the fluid connection in the direction of the other fluid connection point as soon as the fluid pressure at one fluid connection point is higher than at the other fluid connection point.

28. The valve of claim 15, wherein the non-return valve comprises a spring-loaded closing body, which blocks the fluid connection in the direction of the other fluid connection point as soon as the fluid pressure at one fluid connection point is higher than at the other fluid connection point.

29. The valve of claim 14, wherein a fluid passage from the bypass line into the valve chamber is a) normally closed in an actuated position and normally open in an unactuated position of the poppet valve or b) normally open in the actuated position and normally closed in the unactuated position of the poppet valve.

30. The valve of claim 15, wherein a fluid passage from the bypass line into the valve chamber is a) normally closed in an actuated position and normally open in an unactuated position of the poppet valve or b) normally open in the actuated position and normally closed in the unactuated position of the poppet valve.

31. The valve of claim 13, wherein the pilot control of the poppet valve comprises a pilot control piston, which engages through the main piston of the poppet valve, and which is operatively connected to the pilot control piston by means of an energy accumulator.

32. The valve of claim 31, wherein the energy accumulator is a compression spring.
